(19) United States
(12) Patent Application Publication
(10) Pub. No.: US 2003/0092553 A1
(43) Pub. Date: May 15, 2003

(54) Swing-out-rotor laboratory centrifuge with noise abatement system

(75) Inventors: Werner Lurz, Kaltenkirchen (DE); Roland Lippoldt, Leipzig (DE)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(73) Assignee: Eppendorf AG, Hamburg (DE)

(21) Appl. No.: 10/289,937

(22) Filed: Nov. 7, 2002

(30) Foreign Application Priority Data
Nov. 9, 2001 (DE) 10155955.0-23

(51) Int. Cl. B04B 5/02

(52) U.S. Cl. 494/20

(57) ABSTRACT

A laboratory centrifuge comprising at least one bucket receiving sample liquids and mounted in swing-out manner on a rotationally driven rotor and further comprising a noise abatement system to reduce the bucket-generated noise is characterized in that said system consists of at least one turbulence generated mounted on the external surface of the bucket.

The invention relates to a laboratory centrifuge of the kind defined in the preamble of claim 1.

U.S. Pat. No. 3,804,324 describes a laboratory centrifuge of this kind. In centrifuges of this kind, several buckets are supported radially so they may pivot about tangentially mounted shafts and with their centers of gravity outside the shafts.

When the rotor is standing still, the buckets hang down and typically may be loaded with sample liquids, usually in centrifuging vials, for instance at the rate of several vials per bucket, in seats provided for that purpose. As the angular speed rises, the buckets swing outward The advantage of this design is that the liquid level of the vessels as seen within them remains constant.

The design of this species incurs the drawback of the separate, individual configuration of the buckets, which at higher angular speeds entails strong air turbulence and hence strong, interfering noises.

The cited known design therefore is fitted with a device reducing the bucket-generated noises in the form of a closed, sound-absorbing housing. Such a feature however entails the drawback that the heat generated by the buckets' air turbulence remains trapped in the housing and leads to undesired heating of the sample liquid. The conventional remedy is refrigeration, whereby however costs are substantially increased.

The objective of the present invention is to create a laboratory centrifuge of said kind offering a simpler design and lower noise levels.

This problem is solved by the features of claim 1.

In the design of the invention, turbulence generators are mounted on the surface of each bucket to interfere with the air flowing by, which heretofore rested in laminar manner against the buckets, in such a way that, as seen in the direction of flow, there shall be turbulence behind the turbulence generators. As a result there is a significant reduction of the cross-section of the wake behind the buckets. Because of this feature and on account of less interference by the next rotor, there results a significantly reduced noise level.

The invention for the first time is based on the assumption not to dampen the noises generated in laboratory centrifuges after they have been generated, but to reduce them already as they are being generated, and therefore it exploits the previously overlooked, very old aerodynamic insights that are described in GRENZSCHICHT-THEORIE (Boundary Layer Theory) by Dr. Hermann Schlichting, G Braun publishers, Karlsruhe, Germany, 5^{th} edition, on page 39.

Empirical noise reductions up to 6 dB have been attained

Turbulence generators may be mounted on the bucket as seen in the direction of air flow relatively far ahead and also relatively far to the rear. However they must be large in order to act in sufficiently spoiling manner. Accordingly the features of claim 2 are advantageous. High laminar flow is present at the site of maximum bucket diameter. Even very small turbulence generators may be adequately effective in that zone.

Single compact turbulence generators already may abate noise significantly. Advantageously however the turbulence generators shall be elongated or more than one may be used. In this respect claim 3 shall be advantageous. In this manner the linearly extending turbulence generator system is situated in zones of approximately equal flows and thereby it offers an effect which is constant in length.

Turbulence generators may assume the form of recesses in the bucket surface, for instance being holes or an elongated groove. Advantageously however, because offering substantially larger effects, the turbulence generator shall in the form of a salient as defined in claim 4.

A turbulence generator rising above the surface illustratively may be a protruding pin or a collection of protruding pins or also assume the form of a bonded strip of rough sandpaper. Illustratively a wire soldered to a substrate or a rising bead or the like may offer outstanding effectiveness. As disclosed in claim 5, a simple manufacturing technique accordingly is a cylindrical blank milled out to attain the desired shape.

The invention is schematically illustrated in the drawings.

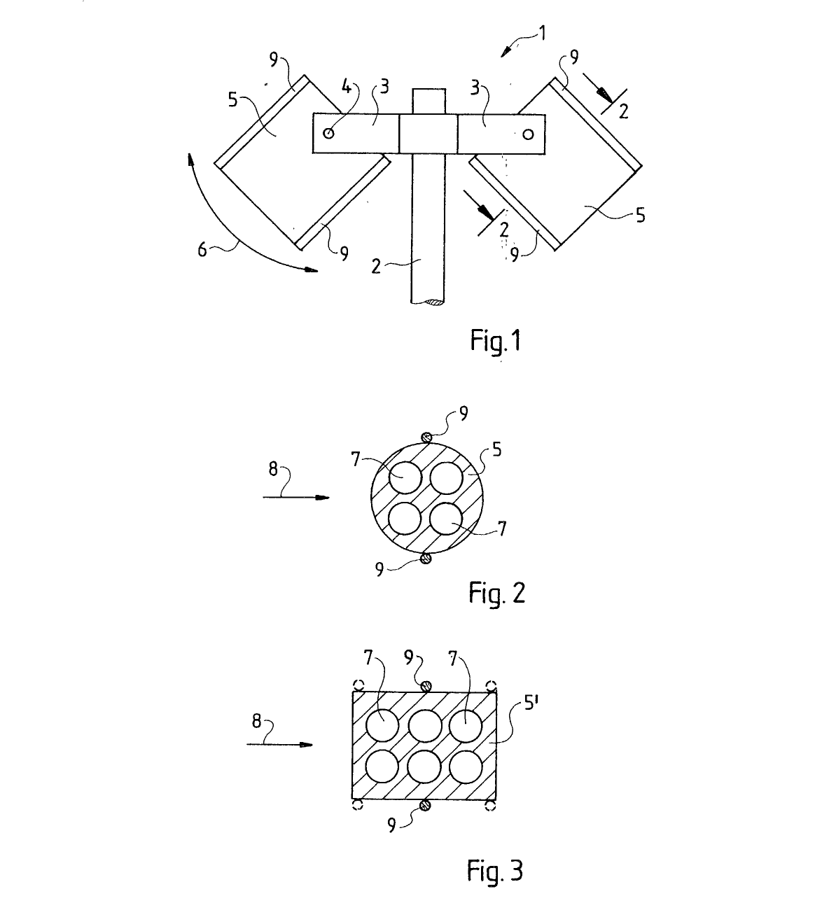

FIG. 1 is a sideview of the swing-out rotor of a centrifuge comprising two swing-out buckets,

FIG. 2 is a cross-section of a bucket along line 2-2 of FIG. 1,

FIG. 3 shows a bucket of another cross-section similarly to the section of FIG. 2,

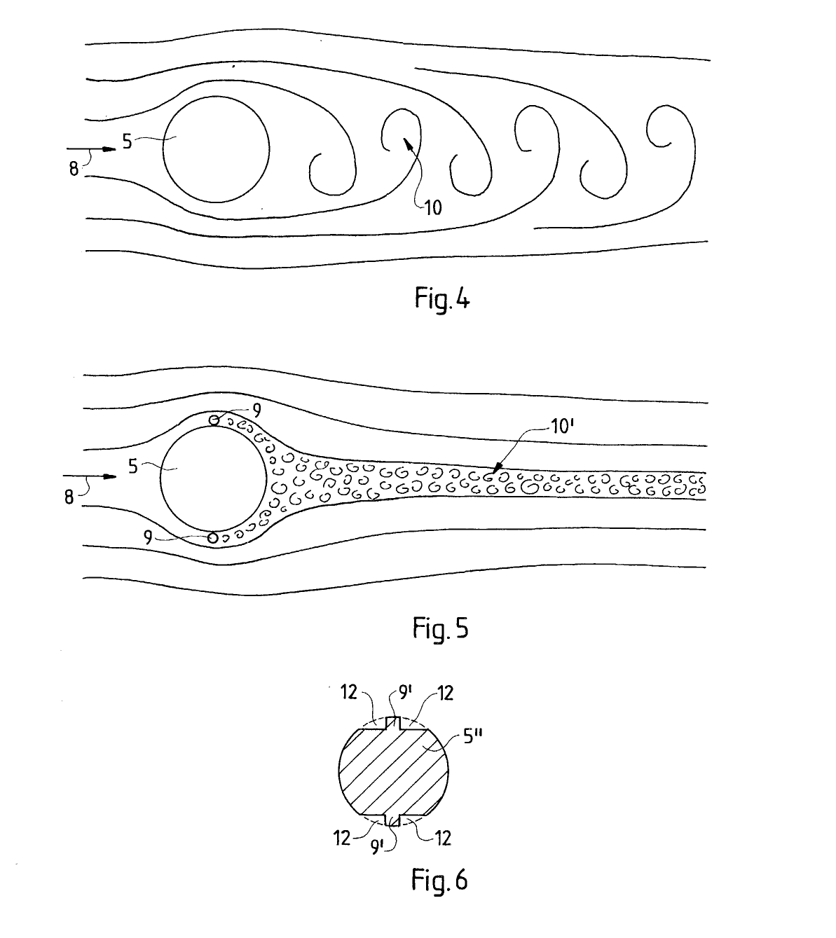

FIG. 4 is a strong simplification of the flow around the bucket of FIG. 2 in the absence of turbulence generator(s),

FIG. 5 is a view similar to FIG. 4 but with incident flow in the presence of turbulence generators, and

FIG. 6 is a cross-section similar to that of FIG. 2 of a bucket of another embodiment variation.

FIG. 1 is a sideview of the rotor 1 of a centrifuge of which the remaining parts are omitted for clarity. The rotor 1 comprises a vertical shaft 2 fitted with radially extending arms 3 which in this embodiment are shown as two mutually opposite arms with one bucket 5 each pivoting about a tangential pivot 4.

The centers of mass of the buckets 5 are outside the pivots 4. When the rotor 1 is immobile, they will hang down. As the angular speed rises, the will pivot outward in the direction of the arrow 6.

FIGS. 2 and 3 show two different cross-sections along line 2-2 of FIG. 1. The bucket 5 of FIG. 2 exhibits a circular cross-section and the bucket 5′ of FIG. 3 exhibits a rectangular cross-section. It is understood that the buckets each comprise several wells 7 to receive matching centrifuging vials holding sample fluids to be centrifuged.

By means of the arrow 8, FIGS. 2 and 3 show the direction of the air flowing around the shaft 2 and incident on the buckets when the rotor 1 is running As regards this direction of air flow incidence, the buckets are fitted in the region of their maximum cross-section, at their surface and in a direction transverse to that of the arrow 8, that is transversely to the direction of the air flow, with wires 9 illustratively affixed by soldering that act as turbulence generators.

FIGS. 4 and 5 show the aerodynamic effect due to the wires 9 as attained at an appropriate Reynolds number. FIG. 4 shows the air flow around the bucket in the absence of wires. FIG. 5 shows the flow when wires are 9 are present.

As shown in FIG. 4, the bucket 5 is immersed in laminar air flow up to its zone of largest cross-section and even substantially beyond. Following the largest cross-section of the bucket, where its cross-section decreases, that is, when seen in the direction of flow, on the back side of the bucket 5, flow detaches and constitutes the shown turbulence alley 10 forming the wake of which the cross-section approximately corresponds to the maximum cross-section of the bucket 5. The turbulence in the turbulence alley 10 generates substantial noise, in particular also due to spoiling at the subsequent rotors that are omitted from FIG. 4.

As shown by FIG. 5, the wires 9 act as turbulence generators entailing turbulent flow behind the wires 9. A turbulent layer is formed at once against the bucket 5 and is adjacent to the wires 9. Said layer offers the advantage over a laminar flow around the bucket that it follows the surface of the bucket farther out. The resultant turbulence alley 10′ therefore exhibits a smaller cross-section than is the case in FIG. 4. The resultant noise is substantially reduced. Noise abatement exceeding 6 dB could be attained in experiments with buckets corresponding to those shown in FIG. 5.

The turbulence generators of the shown embodiment are in the form of apposed wires 9. However the wires 9 may be replaced by other turbulence generators on the bucket, for instance by outwardly bulging beads. Again grooves fashioned in the bucket surface may exhibit corresponding effects.

In lieu of the linearly running turbulence generators 9 shown in the Figures as being wires or of correspondingly elongated grooves, individual turbulence generators assuming a narrow, point-like geometry also may be used, for instance in the form of projecting pins or in the form of holes. The latter geometries may be arrayed staggered behind each other and optimally they shall be arrayed linearly along the zone of maximum diameter of the bucket and transversely to the direction of flow.

The spoiler edges generated by the wires 9 in the above embodiment are optimally situated in the zone of largest cross-section. This zone of largest cross-section running over a substantial length (FIG. 3), the spoiler edges, as shown in FIG. 3, may be configured at the center of the bucket 5′ or also near the front or rear corners as indicated by dashed lines in FIG. 3.

However, as shown by FIG. 2 with respect to the bucket 5, turbulence generators also may be configured much more forward, that is, toward the arrow 8. In that case however they must be made larger to attain a corresponding effect.

FIG. 6 shows an embodiment variation over that of FIG. 2 wherein the turbulence generators are in the form of offsets 9′ milled out a cylindrical blank (dashed lines). This design may be implemented in integral manner using conventional machine tools.

1. A laboratory centrifuge comprising at least one bucket (5, 5′, 5″) receiving sample liquids and supported on a rotationally driven rotor (1) and further comprising a noise abating system (9, 9′) to reduce the bucket-induced noise,
characterized in that said system consists of at least one turbulence generator (9, 9′) mounted on the external surface of the bucket (5, 5′).

2. Laboratory centrifuge as claimed in claim 1, characterized in that the turbulence generator (9, 9′) is configured transversely to the air flow direction (8) in the region of the largest diameter of the bucket (5, 5′).

3. Laboratory centrifuge as claimed in claim 1, characterized in that the turbulence generator (9, 9′) or a configuration of several turbulence generators is configured linearly transversely to the direction of flow.

4. Laboratory centrifuge as claimed in claim 1, characterized in that the turbulence generator (9, 9′) is configured rising from the surface of the bucket (5, 5′).

5. Laboratory centrifuge as claimed in claim 4, characterized in that the turbulence generator is configured as an offset (9′) between two milled-out segments (12) that runs parallel to the axis of a cylindrical bucket (5″).
